(19) United States
(12) Patent Application Publication
(10) Pub. No.: US 2008/0036962 A1
(43) Pub. Date: Feb. 14, 2008

(54) Watch device containing eyeglasses

(76) Inventor: Daniel Alitowski, New York, NY (US)

Correspondence Address: Daniel Alitowski;# 6B, 201 West 77th Street, New York, NY, 10024, US

(21) Appl. No.: 11/503,581

(22) Filed: Aug. 14, 2006

(51) Int. Cl. G02C 5/08

(52) U.S. Cl. 351/63

(57) ABSTRACT

A watch device containing eyeglasses is provided, which includes a housing, a watch mechanism comprised into or onto the housing, and eyeglasses configured with a folding mechanism for enabling the eyeglasses to be foldable into the housing, in which a frame of the eyeglasses is comprised of a multiplicity of frame segments and the folding mechanism is comprised of a plurality of strategically disposed joints joining the frame segments, the frame segments and joints being configured to enable the eyeglasses to be reversibly folded into the housing.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to wearable accessories. More particularly, the invention relates to a watch that contains foldable eye glasses.

### BACKGROUND OF THE INVENTION

It is a common experience, for those who need eyeglasses, to forget eyeglasses, in critical situation; for example, when needed to read a menu or enjoy a theatre or sporting event or for driving motor vehicles.

In view of the foregoing, there is a need for a device that reduces the likelihood that eyeglass wearers do not have eyeglasses on hand when needed.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary lower portion of a wristwatch that comprises a containing compartment, in accordance with an embodiment of the present invention;

FIG. 2 illustrates an exemplary watch face cover, which is configured to pivotally join with and cover lower portion of FIG. 1, in accordance with an embodiment of the present invention;

FIG. 3 illustrates an eyeglass watch container, which is an assembly of watch face cover to be pivotally joined with cover lower portion, in accordance with an embodiment of the present invention;

FIGS. 4a and b illustrate exemplary foldable eyeglasses in its unfolded and folded modes, respectively, which eyeglasses are suitable for to be contained within containing compartment of FIG. 3, in accordance with an embodiment of the present invention; and

FIG. 5 illustrates foldable eyeglasses partially folded modes between the unfolded and folded modes.

Unless otherwise indicated illustrations in the figures are not necessarily drawn to scale.

### SUMMARY OF THE INVENTION

To achieve the forgoing and other objects and in accordance with the purpose of the invention, a variety of techniques are described for a watch device and foldable eyeglasses containable within the watch.

In one embodiment of the present invention, a watch device containing eyeglasses is provided, which includes a housing, a watch mechanism comprised into or onto the housing, and eyeglasses configured with a folding mechanism for enabling the eyeglasses to be foldable into the housing, in which a frame of the eyeglasses is comprised of a multiplicity of frame segments and the folding mechanism is comprised of a plurality of strategically disposed joints joining the frame segments, the frame segments and joints being configured to enable the eyeglasses to be reversibly folded into the housing.

Other embodiments optionally include some or all of the following in which: the folding mechanism is configured to enable the lenses of the eyeglasses to fold over one another; frame segments of the folding mechanism that go over the ears during normal use are configured fold around the lenses or fold smaller than the diameter of the lenses when in their folded position; the folding mechanism joints are hinges; and/or the folding mechanism joints are interlocking snaps or screws.

In another embodiment of the present invention, foldable eyeglasses are provided that are suitable for folding into a watch device, the foldable eyeglasses includes eyeglasses configured with a folding mechanism for enabling the eyeglasses to be foldable into a watch housing, and in which a frame of the foldable eyeglasses is comprised of a multiplicity of frame segments and the folding mechanism is comprised of a plurality of strategically disposed joints joining the frame segments, the frame segments and joints being configured to enable the foldable eyeglasses to be reversibly folded into the housing.

In other embodiments, means are provided to achieve some or all of the foregoing function.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

One observation of the instant invention is that people are used to carrying or wearing a watch is wherever they go and that this ubiquity can be leveraged as a means to make available eyeglasses.

In the preferred embodiment of the present invention, a conventional watch (e.g., a wristwatch) is adapted to have a container compartment, which adapted watch will open and reveal a pair of foldable eyeglasses that can be taken out and worn.

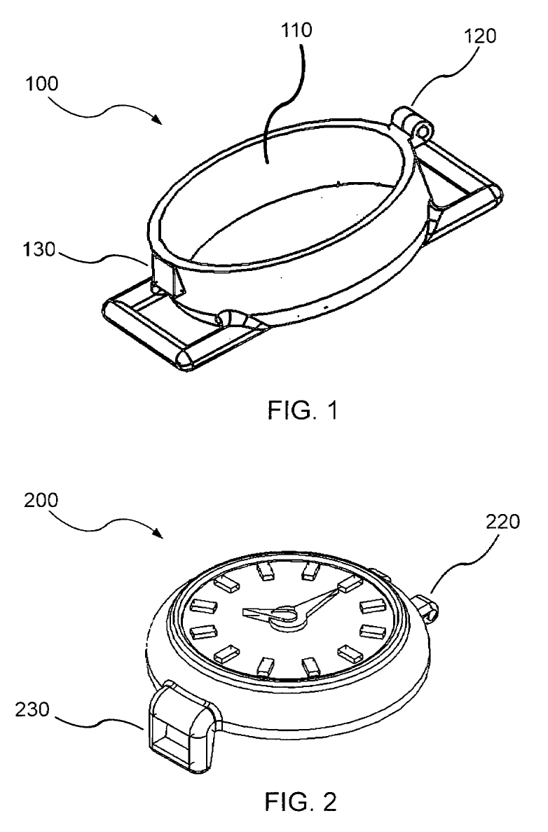

FIG. 1 illustrates an exemplary lower portion 100 of a wristwatch that comprises a containing compartment 110, in accordance with an embodiment of the present invention. Lower portion 100 is configured with a hinge joint portion 120 for pivotally joining a watch face (see FIG. 2) cover and a locking means 130, which is designed to match with a counterpart component on the watch face cover to hold the cover closed until released by the user.

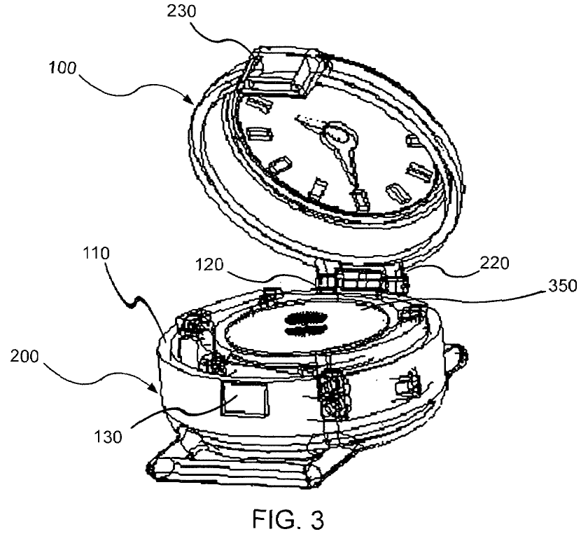

FIG. 2 illustrates an exemplary watch face cover 200, which is configured to pivotally join with and cover lower portion 100 of FIG. 1, in accordance with an embodiment of the present invention. Watch face cover 200 is sized to cover lower portion 100 and is configured with a counterpart hinge joint portion 220 for pivotally joining with hinge joint portion 120 on lower portion 100, thereby enabling watch face cover 200 to be opened from and closed onto containing compartment 110 (see FIG. 3). A locking means 230 is configured to mate with locking means 130 for removably locking watch face cover 200 onto cover lower portion 100. Any conventional locking means will work, including, but not limited to, snap and clasp locking mechanisms.

FIG. 3 illustrates an eyeglass watch container 300, which is an assembly of watch face cover 200 to be pivotally joined with cover lower portion 100, in accordance with an embodiment of the present invention. Although a hinge joint is used in this example, any conventional means to removably cover the container portion may be used. By way of example, and not limitation, in alternate embodiments of the present invention (not shown), instead of a vertical pivoting hinge joint, a horizontally pivoting joint may be implemented to enable the watch cover to be horizontally rotated. It is contemplated that those skilled in the art will recognize, in light of the teachings of the present invention, a multiplicity of alternative and suitable means of movably joining the watch face cover and the container lower portion; for example, without limitation, clasps, pins, and hinges, having a watch top that will unscrew or pop off by applying pressure. Wristbands (not shown) may be joined as with any conventional wristwatch. As will be described in more detail below, containing compartment 110 shown in the figure is configured to properly store a pair of foldable eyeglasses 350 shown in their folded configuration. When use of foldable eyeglasses 350 is desired, the watch cover is opened, and they removed and unfurled back to the fully opened mode.

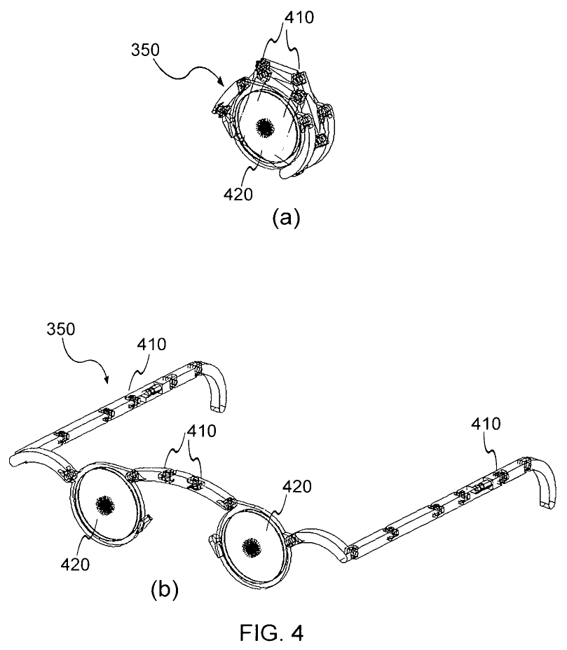

FIGS. 4a and b illustrate exemplary foldable eyeglasses 350 in its folded and unfolded modes, respectively, which eyeglasses are suitable for to be contained within containing compartment 110 as shown in FIG. 3, in accordance with an embodiment of the present invention. As shown in the Figures, foldable eyeglasses 350 are provided with a plurality of strategically position joints 410 (e.g., hinges or pins) which enable the folding of foldable eyeglasses 350 into that shown in FIG. 4b. Hinge joints in the plane of eyeglass lenses 420 and the flame segments there between are configured to collapse around eyeglass lenses 420. Eyeglass lenses 420 may be shaped as needed for the particular application (e.g., round and rectangle shapes), the eyeglass container being sized and shaped accordingly to properly contain the folded eyeglasses. In alternate embodiments of the present application, at least a portion of the eyeglass ear piece arms are made of a flexible material that permits the proper folding/bending into the eyeglass container. Similarly, in yet alternate embodiments of the present application, at least a portion of the whole eyeglass frame is made of a flexible material that permits the proper folding/bending into the eyeglass container. The proper selection of a suitable flexible material will be readily recognized by those skilled in the art; for example, without limitation, pieces of wire, shape memory materials, etc.

Those skilled in the art will recognizes in light of the teachings of the present invention, a multiplicity of alternative and suitable means of configuring foldable eyeglasses. Other possible ways to configure suitable foldable eyeglasses include, but are not limited to, having no eyeglass ear pieces whereby the eyeglasses simply rest on the nose and can be worn as a pince-nez, and configuring the eyeglasses to require construction thereof (e.g., ear pieces may be snapped on and extended).

Any suitable conventional materials may be used to fabricate the foldable eyeglasses and watch container portion; for example, without limitation, plastics, metals, and/or glass.

In alternate embodiments of the present invention (not shown), instead of a wristwatch implementation that houses the foldable eyeglasses, alternate forms may be used, including, but not limited to, a pocket-watch, worn as a pin or a keychain or around the neck as a necklace.

Having fully described at least one embodiment of the present invention, other equivalent or alternative methods of providing an eyeglasses containing watch device according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A watch device containing eyeglasses, the watch device comprising:
a housing;
a watch mechanism comprised into or onto said housing;
means for enabling eyeglasses to be foldable into said housing; and
means for integrating said watch mechanism into said housing.

2. The watch device of claim 1, in which said housing is a watch housing that has a top portion and a bottom portion, both halves being hingedly joined, and said top portion being configured to comprise said watch mechanism, and said top and bottom halves being further configured with a storage cavity operable for, when the halves are joined, containing said eyeglasses when folded using said eyeglasses folding means.

3. The watch device of claim 2, in which said watch housing is configured to be operable as a pocket watch housing.

4. The watch device of claim 2, in which said watch housing is configured to be operable as a wristwatch housing.

5. The watch device of claim 3, in which said watch housing comprises said foldable eyeglasses.

6. The watch device of claim 2, further comprising means for removabley retaining said top and bottoms halves in their closed position.

7. The watch device of claim 2, further comprising a screwing mechanism configured on a non-hinged side of said housing, and configured to enable the locking (releasing) said halves in their closed (open) position upon proper screwing engagement of said screwing mechanism.

8. The watch device of claim 2, further comprising a snapping mechanism configured on a non-hinged side of said housing, and configured to enable the locking (releasing) said halves in their closed (open) position upon proper pulling (pushing) engagement of said snapping mechanism.

9. The watch device of claim 1, in which said housing is a watch housing that has a top portion and a bottom portion, both halves being removably joinable, and said top portion being configured to comprise said watch mechanism, and said top and bottom halves being further configured with a storage cavity operable for, when the halves are joined, containing said eyeglasses when folded using said eyeglasses folding means.

10. The watch device of claim 1, in which a frame of the eyeglasses comprises a plastic, metal or wire construction.

11. The watch device of claim 1, in which a frame of the eyeglasses is comprised of a suitably compliant material to enable the eyeglasses to be more readily folded into said housing.

12. The watch device of claim 1, in which said housing is comprised of a plastic or metal construction.

13. A watch device containing eyeglasses, the watch device comprising:
a housing;
a watch mechanism comprised into or onto said housing; and
eyeglasses configured with a folding mechanism for enabling said eyeglasses to be foldable into said housing, in which a frame of the eyeglasses is comprised of a multiplicity of frame segments and said folding mechanism is comprised of a plurality of strategically disposed joints joining said frame segments, said frame segments and joints being configured to enable the eyeglasses to be reversibly folded into said housing.

14. The watch device of claim 13, in which said folding mechanism is configured to enable the lenses of the eyeglasses to fold over one another.

15. The watch device of claim 14, in which frame segments of said folding mechanism that go over the ears during normal use are configured fold around the lenses or fold smaller than the diameter of the lenses when in their folded position.

16. The watch device of claim 13, in which said folding mechanism joints are hinges.

17. The watch device of claim 13, in which said folding mechanism joints are interlocking snaps or screws.

18. Foldable eyeglasses suitable for folding into a watch device, the foldable eyeglasses comprising eyeglasses configured with a folding mechanism for enabling said eyeglasses to be foldable into a watch housing, and in which a frame of said foldable eyeglasses is comprised of a multiplicity of frame segments and said folding mechanism is comprised of a plurality of strategically disposed joints joining said frame segments, said frame segments and joints being configured to enable said foldable eyeglasses to be reversibly folded into said housing.

19. The foldable eyeglasses of claim 18, in which said folding mechanism comprises means for enabling eyeglasses to be foldable into said watch housing.

20. The watch device of claim 18, in which said folding mechanism is configured to enable the lenses of the foldable eyeglasses to fold over one another.
